(19) United States
(12) Patent Application Publication
(10) Pub. No.: US 2014/0042088 A1
(43) Pub. Date: Feb. 13, 2014

(54) BUBBLE GENERATING SYSTEM AND METHOD FOR WASTEWATER TREATMENT

(71) Applicants: Norifumi Yoshida, Hyougo-Ken (JP); Akinori Ikeda, Shimonoseki-shi (JP); Chengguo Zhang, Shanghai (CN)

(72) Inventors: Norifumi Yoshida, Hyougo-Ken (JP); Akinori Ikeda, Shimonoseki-shi (JP); Chengguo Zhang, Shanghai (CN)

(21) Appl. No.: 13/980,553

(22) PCT Filed: Jan. 18, 2012
(86) PCT No.: PCT/IB12/00192

§ 371 Date: Aug. 21, 2013

Related U.S. Application Data
(63) Continuation of application No. 13/352,817, filed on Jan. 18, 2012, now abandoned.
(60) Provisional application No. 61/434,610, filed on Jan. 20, 2011.
(60) Provisional application No. 61/434,610, filed on Jan. 20, 2011.

(51) Int. Cl. C02F 3/02

(52) U.S. Cl. CPC C02F 3/02
USPC 210/629; 261/121.1; 261/87

(57) ABSTRACT

A bubble generating system is provided for use with a gas supply and a container having liquid therein. The gas supply can supply a flow of gas. The bubble generating system includes a gas provider, a first bubble generator and a second bubble generator. The gas provider has an input port, a first output port and a second output port, wherein input portion can connect to the gas supply. Each bubble generator has an inlet and an outlet and is connected to the gas provider. The first bubble generator is arranged to output the first portion of the flow of gas in a first direction. The second bubble generator is arranged to output the second portion of the flow of gas in a second direction, wherein the first direction is different from the second direction.

The present application claims priority from U.S. Provisional Application No. 61/434,610 filed Jan. 20, 2011, the entire disclosure of which is incorporated herein by reference.

### BACKGROUND

The present invention relates to a bubble generator used for waste water treatment.

In industrial plants, it is a general practice to treat wastewater contaminated with animal, mineral or vegetable oil with aerobic bacteria to digest contaminants. In such a wastewater purification system, it is necessary to mix fine bubbles into wastewater to encourage oxygen respiration and create a favorable living environment for aerobic bacteria. Conventionally, such an apparatus to mix or generate fine bubbles into wastewater is placed in wastewater to be treated, and the mechanism that works by emitting air from an air outlet provided in the lower end section of a pipe, producing a spiral flow of water by guiding an upward water flow induced by this flow of air with spirally arranged vanes, and mixing bubbles within the rising water flow, while fractionalizing bubbles to promote wastewater purification with a bubble breaker having a number of projections placed inside the pipe, has been used.

In a particular water treatment system, grease is removed. In some localities, waist grease from cooking vats at restaurants is dumped into the local sewage system. To minimize damage from directly dumping the grease into the sewage system, the grease is stored in a holding tank with water. This holding tank is conventionally called a grease trap. The water, having grease therein, is treated until the amount of grease is below a predetermined acceptable level. The treated water and grease mixture may then be released into the local sewage system.

In some conventional grease trap cleaning systems, a detergent is added to the water to breakdown the grease. However, in some cases, detergents may be harmful to the local sewage system. In those cases, biological microbes may be added to the water to breakdown the grease. The biological microbes require oxygen to metabolize the grease. In such cases, it is beneficial to generate bubbles in the water with a conventional bubble mixing apparatus as described above.

With respect to the conventional bubble generating apparatus described above, it has been believed for many years that the creation of a spiral flow of water is instrumental in achieving efficient generation and mixing of bubbles into wastewater. While a method to fractionize bubbles by letting air (bubbles) collide in projections in a flow of water is a typical practice, wastewater purification can be performed more effectively and efficiently by inducing cavitation in wastewater and fractionizing bubbles with a change of water pressure. To induce cavitation in wastewater, it is necessary to increase the velocity of a water flow. From this perspective, a spiral flow of water employed in the conventional bubble mixing apparatus inhibits the generation of bubbles in wastewater. This will now be described in greater detail with reference to FIGS. 1-6C.

FIG. 1 illustrates an oblique view of a grease trap 100 and a conventional grease trap cleaning system 106.

As shown in the figure, grease trap 100 includes an input port 102 and an output port 104. Conventional cleaning system 106 includes an air supply line 108, a main line 110, t-lines 112, 114, 116 and 118, and bubble generators 120, 122, 124, 126, 128, 128, 130, 132 and 134.

Input port 102 is arranged to receive a flow of water from a sewer system (not shown). Output port 104 is arranged opposite of input port 102 to output material into the sewer system (not shown). Air supply line 108 is arranged to receive air from an air source (not shown). Main line 110 is arranged to receive air from air supply line 108. T-lines 112, 114, 116 and 118 are arranged to receive air from main line 110. Bubble generators 120 and 122 are arranged to receive air from t-line 112. Bubble generators 124 and 126 are arranged to receive air from t-line 114. Bubble generators 128 and 130 are arranged to receive air from t-line 116. Bubble generators 132 and 134 are arranged to receive air from t-line 118.

FIG. 2 illustrates a cross sectional view of bubble generator 134 of FIG. 1.

As shown in FIG. 2, bubble generator 134 includes a housing portion 204, a fan-shaped disc portion 206, a projections disc portion 208, a fan-shaped disc portion 210, a projections disc portion 212, a fan-shaped disc portion 214, a spacer 216, a fan-shaped disc portion 218, a projections disc portion 220, a fan-shaped disc portion 222 and a projections disc portion 224. Housing portion 204 includes a top opening 226 and a bottom opening 228. T-line 118 ends with an air outlet 230.

Fan-shaped disc portion 206, projections disc portion 208, fan-shaped disc portion 210, projections disc portion 212, fan-shaped disc portion 214, spacer 216, fan-shaped disc portion 218, projections disc portion 220, fan-shaped disc portion 222 and projections disc portion 224 are placed in the passage of rising air discharged from the air outlet 230. Spacer 216 maintains a desirable interval between the other elements within bubble generator 134, prevents clogging between the other elements within bubble generator 134, or maintains a required overall height with a reduced number other elements within bubble generator 134.

Each of fan-shaped disc portion 206, projections disc portion 208, fan-shaped disc portion 210, projections disc portion 212, fan-shaped disc portion 214, spacer 216, fan-shaped disc portion 218, projections disc portion 220, fan-shaped disc portion 222 and projections disc portion 224 set appropriately with four rivets (not shown) to keep each element stationary.

A more detailed discussion of the fan-shaped disc portions and the projections disc portions will now be provided with reference to FIGS. 3-4.

FIG. 3 is a plan view of fan-shaped disc portion 206 of FIG. 2.

As shown in FIG. 3, fan-shaped disc portion 206 includes a cylindrical main body 302 and a plurality of projections, a sample projection indicated as item 304. Each of the plurality of projections extends from cylindrical main body 302 to a tip, a sample time indicated as item 306. Each of the plurality of projections have a length such that the tips are separated to form a hole 308 at the center of cylindrical main body 302.

Each of the plurality of projections of fan-shaped disc portion 206 is angled similar to a fan blade. Accordingly, as air bubbles pass through fan-shaped disc portion 206, the plurality of projections force the air bubbles toward the plurality of tips. A majority of the air bubbles are funneled toward hole 308.

FIG. 4 is a plan view of projections disc portion 208 of FIG. 2.

As shown in FIG. 4, projections disc portion 208 includes a cylindrical main body 402 and a plurality of projections, a sample projection indicated as item 404. Each of the plurality of projections extends from cylindrical main body 402 to a tip, a sample time indicated as item 406. Each of the plurality of projections have a length such that the tips are separated to form a hole 408 at the center of cylindrical main body.

Each of the plurality of projections of projections disc portion 208 includes a plurality of spikes. Accordingly, as air bubbles pass through projections disc portion 208, the plurality of spikes break up the air bubbles into smaller air bubbles. Further, the plurality of tips (of the projections) of projections disc portion 208 are shaped into a sharp angle at hole 408, where their tips face each other. Still further, the plurality of tips (of the projections) of projections disc portion 208 are made to a design length so as to form hole 408 at a size sufficient to induce cavitation.

Returning to FIG. 2, in operation, T-line 118 provides air to bubble generator 134. The air escapes T-line 118 from air outlet 230 as bubbles of various sizes. The bubbles an travels up toward fan-shaped disc portion 206, a projections disc portion 208, a fan-shaped disc portion 210, a projections disc portion 212, a fan-shaped disc portion 214, a spacer 216, a fan-shaped disc portion 218, a projections disc portion 220, a fan-shaped disc portion 222 and a projections disc portion 224.

As the bubbles pass through projections disc portion 224 they are broken into smaller bubbles from the plurality of spikes, as discussed above with reference to FIG. 4. Further some bubbles passing through hole 408 become very small as a result of the cavitation.

The smaller bubbles continue to rise past fan-shaped disc portion 222, which forces more bubbles toward the center, as discussed above with reference to FIG. 3. Some bubbles are not forced toward the center and pass between the plurality of projections.

The smaller bubbles continue to rise past projections disc portion 220. The portion of the bubbles that were not forced toward the center of fan-shaped disc portion 222 are broken into even smaller bubbles from the plurality of spikes, as discussed above with reference to FIG. 4. The portion of the bubbles that were forced toward the center of fan-shaped disc portion 222 pass through hole 408 of projections disc portion 220 and become very small as a result of the cavitation.

The process repeats, wherein more and more bubbles are forced toward the center by fan-shaped disc portions 218, 214, 210 and 206. Further, more and more bubbles are forced through the centers of projections disc portions 212 and 208. As a result, the original air bubbles escaping air outlet 230 are broken into very small bubbles as they finally escape top opening 226 of air bubble generator 134.

The larger number of smaller air bubbles increase the effectiveness of an aerobic process to break down grease in the grease trap. While creating the bubbles, a flow of the water in the grease trap is also created. This will be further described with reference to FIG. 5.

FIG. 5 illustrates fluid flows associated in a cross sectional view of bubble generator 134 of FIG. 1.

As shown in FIG. 5, fluid flows out opening 212 of bubble generator 134 as indicated by curved arrow 502. Fluid flows along a path indicated by arrow 504 and curved arrow 506, wherein it may reenter bubble generator 134 at opening 214. Similarly, fluid flows out opening 212 of bubble generator 134 as indicated by curved arrow 508. Fluid flows along a path indicated by arrow 510 and curved arrow 512, wherein it may reenter bubble generator 134 at opening 214.

The combination of the generation of the smaller bubbles and the generation of the fluid flow remove grease from the grease trap. In particular, biological microbes may be added to the grease trap to break down the grease. The microbes need air, which is provided by the bubbles. This will be further described with reference to FIG. 6.

FIG. 6A is a cross-sectional view of grease trap 100 and a conventional grease trap cleaning system 106 along t-line 118 at a time t₀.

As shown in the figure, grease trap 100 is filled with water 602, which includes grease particles 604. Further, a layer of grease 606 has formed along the walls and bottom of grease trap 100.

At some point, known biological microbes may be added to water 602 to break down grease particles 604. The biological microbes required oxygen to breakdown grease particles 604.

FIG. 6B is a cross-sectional view of grease trap 100 and a conventional grease trap cleaning system 106 along t-line 118 at a time t₁, wherein T-line 118 has been providing air to bubble generators 134 and 132 for a period of time.

As shown in the figure, bubble generator 134 generates a stream of very small bubbles 620, whereas bubble generator 622 generates a stream of very small bubbles 622. Stream of very small bubbles 620 and stream of very small bubbles 622 greatly oxygenate water 602. The oxygenation enables breakdown of grease particles 604 by the known biological microbes. By comparing FIG. 6A with FIG. 6B, the number of grease particles 604 is greatly reduced.

As discussed above with reference to FIG. 5, bubble generator 134 creates fluid flow in the directions indicated by arrows 502, 504, 506, 508, 510 and 512. Similarly, bubble generator 132 creates fluid flow in the directions indicated by arrows 608, 610, 612, 614, 616 and 618.

The Bernoulli principle dictates that fluid flow in a direction will provide a decrease in pressure in a direction normal to the fluid flow. In the case of fluid flow of FIG. 6B, the fluid flowing as indicated by arrow 504 has a velocity in the direction indicated by arrow 620. As a result of the Bernoulli principle, the fluid flow in the direction indicated by arrow 620 creates a decreased pressure in a direction normal to arrow 602, indicated by arrow 626. The decrease in pressure provides a pulling force from the wall of grease trap 100 in the direction of arrow 626.

The pulling force from the wall of grease trap 100 in the direction of arrow 626 pulls grease from the wall of grease trap 100. Once the grease is freed from the wall, the microbes in the oxygenated water may more easily break it down.

Similar the fluid flow in the direction indicated by arrow 504, fluid flow in the direction indicated by arrows 506, 512, 616, 618 and 612 has a velocity in the direction indicated by arrows 622, 624, 632, 634 and 636, respectively. Further, the fluid flows in the direction indicated by arrows 622, 624, 632, 634 and 636, respectively, creates a decreased pressure in a direction indicated by arrows 628, 630, 638, 640 and 642, respectively.

As a result of the pulling forces from the wall of grease trap 100 grease is pulled from the entire wall, as shown in FIG. 6C.

FIG. 6C is a cross-sectional view of grease trap 100 and a conventional grease trap cleaning system 106 along t-line 118 at a time t₂, wherein T-line 118 has been providing air to bubble generators 134 and 132 for an extended period of time.

As shown in the figure, no more grease particles are present in water 602. Further, layer of grease 606 is no longer present on the walls of grease trap 100.

What is needed is a more efficient system and method for cleaning grease from a grease trap.

### BRIEF SUMMARY

In accordance with example embodiments of the present invention, a more efficient system and method is provided for cleaning grease from a grease trap.

In accordance with an aspect of the present invention, a bubble generating system is provided for use with a gas supply and a container having liquid therein. The gas supply can supply a flow of gas. The bubble generating system includes a gas provider, a first bubble generator and a second bubble generator. The gas provider has an input port, a first output port and a second output port, wherein input portion can connect to the gas supply. The first bubble generator has a first inlet and a first outlet and is connected to the gas provider such that a first portion of the flow of gas is provided to the first inlet from the first output port. The second bubble generator has a second inlet and a second outlet and is connected to the gas provider such that a second portion of the flow of gas is provided to the second inlet from the second output port. The first bubble generator is arranged to output the first portion of the flow of gas from the first outlet into the liquid in a first direction. The second bubble generator is arranged to output the second portion of the flow of gas from the second outlet into the liquid in a second direction, wherein the first direction is different from the second direction.

In accordance with another aspect of the present invention, a bubble generating system is provided for use with a gas supply and a container having liquid therein. The gas supply can supply a flow of gas. The bubble generating system includes a first inlet, a cylindrical main body and a plurality of projections. The first inlet can connect to the gas supply to receive a first portion of the flow of gas. The cylindrical main body has a center, can rotate about a rotational axis and is arranged to receive the first portion of the flow of gas from the first inlet in a direction along the rotational axis. The plurality of projections are connected to the cylindrical main body, wherein each of the plurality of projections extends from the cylindrical main body toward the center, and wherein each of the plurality of projections has a respective tip. The plurality of tips of the plurality of projections are arranged around an area of the center of the cylindrical main body. The area has a size to induce cavitation in the first portion of the flow of gas at the area. The plurality of projections are disposed to engage the first portion of the flow of gas to induce a rotation in a first direction about the rotational axis.

In accordance with another aspect of the present invention, a method is provided for using a bubble generating system with a gas supply and a container having liquid therein. The gas supply can supply a flow of gas. The bubble generating system includes a gas provider, a first bubble generator and a second bubble generator. The gas provider has an input port, a first output port and a second output port, wherein the input port is connect to the gas supply. The first bubble generator has a first inlet and a first outlet and is connected to the gas provider such that a first portion of the flow of gas is provided to the first inlet from the first output port. The second bubble generator has a second inlet and a second outlet and is connected to the gas provider such that a second portion of the flow of gas is provided to the second inlet from the second output port. The method includes: arranging the first bubble generator in the liquid to output the first portion of the flow of gas from the first outlet into the liquid in a first direction; arranging the second bubble generator in the liquid to output the second portion of the flow of gas from the second outlet into the liquid in a second direction; and providing the flow of gas to the input port, wherein the first direction is different from the second direction.

Additional advantages and novel features of the invention are set forth in part in the description which follows, and in part will become apparent to those skilled in the art upon examination of the following or may be learned by practice of the invention. The advantages of the invention may be realized and attained by way of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an oblique view of a grease trap and a conventional grease trap cleaning system;

FIG. 2 illustrates a cross sectional view of bubble generator of FIG. 1;

FIG. 3 is a plan view of a fan-shaped disc portion of FIG. 2;

FIG. 4 is a plan view of a projections disc portion of FIG. 2;

FIG. 5 illustrates fluid flows associated in a cross sectional view of the bubble generator of FIG. 1;

FIG. 6A-C are a cross-sectional view of the grease trap of FIG. 1, and a conventional grease trap cleaning system at a time t₀, t₁ and t₂, respectively;

FIG. 7 illustrates a cross sectional view of an example bubble generator, in accordance with aspects of the present invention;

FIG. 8 is an oblique view of a fan-shaped disc portion of FIG. 7, in accordance with aspects of the present invention;

FIG. 9 is an oblique view of the fan-shaped disc portion of FIG. 8, stacked on top of a another fan-shaped disc portion, in accordance with aspects of the present invention;

FIG. 10 is an oblique view of fan-shaped disc portion of FIG. 8, stacked on top of a another fan-shaped disc portion, in accordance with aspects of the present invention;

FIGS. 11A-C are a cross-sectional view of the grease trap of FIG. 1, and a grease trap cleaning system in accordance with aspects of the present invention at a time t₀, t₁ and t₂, respectively; and

FIG. 12 is a cross-sectional view of the grease trap of FIG. 1, and another grease trap cleaning system in accordance with aspects of the present invention at a time t₁.

### DETAILED DESCRIPTION

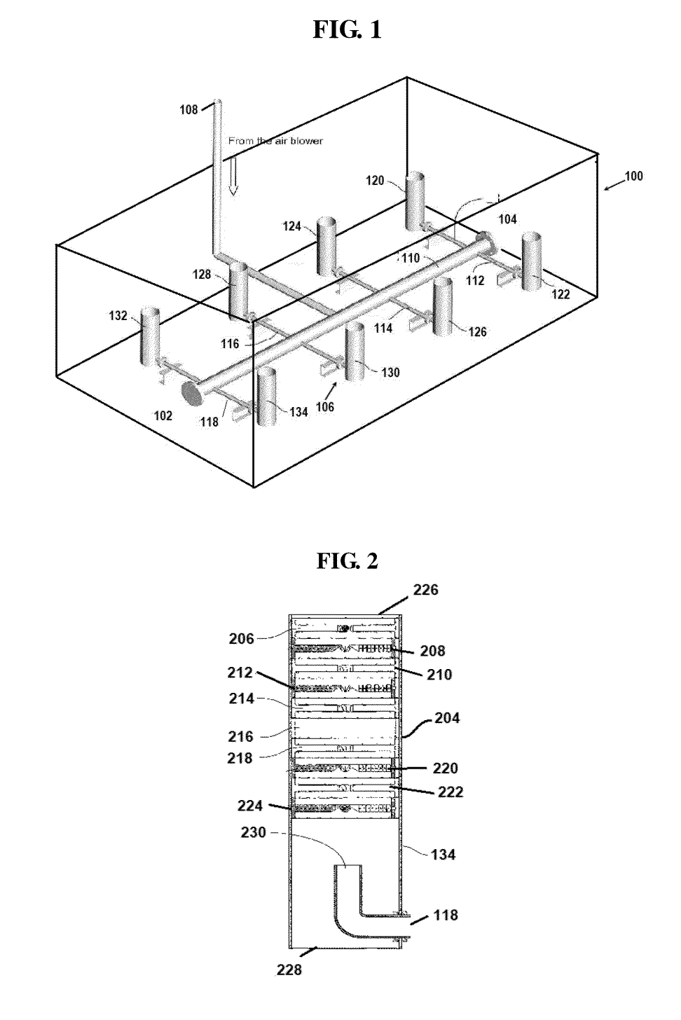

In accordance with an aspect of the present invention, a bubble generator uses fan-shaped disc portions that are rotatable, as opposed to stationary as in the conventional bubble generators discussed above with reference to FIGS. 1-3. The rotatable fan-shaped disc portions of the present invention promote additional turbulence and increase the likelihood of breaking up air bubbles into smaller air bubbles.

In accordance with another aspect of the present invention, bubble generators are arranged to output a flow of air in different directions. In a specific example embodiment, two bubble generators are arranged to output a flow of air in opposite directions. The different directions of air flow promote additional turbulence.

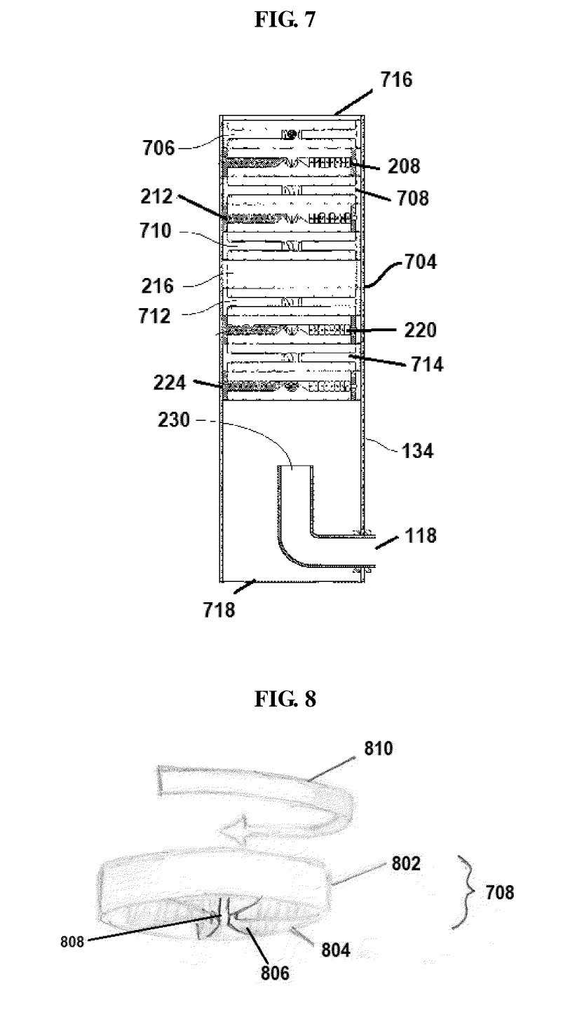

The additional turbulence created by the aspects of the present invention promote a more rapid breakdown of grease in a grease trap. These example aspects will now be further described with reference to FIGS. 7-12.

FIG. 7 illustrates a cross sectional view of an example bubble generator 702, in accordance with aspects of the present invention.

As shown in the figure, bubble generator 702 includes a housing portion 704, a fan-shaped disc portion 706, projections disc portion 208, a fan-shaped disc portion 708, projections disc portion 212, a fan-shaped disc portion 710, spacer 216, a fan-shaped disc portion 712, projections disc portion 220, a fan-shaped disc portion 714 and projections disc portion 224. To simplify the discussion, a discussion of elements of bubble generator 702 that are common to bubble generator 134 as discussed above with reference to FIG. 2 will not be repeated.

Fan-shaped disc portion 706, projections disc portion 208, fan-shaped disc portion 708, projections disc portion 212, fan-shaped disc portion 710, spacer 216, fan-shaped disc portion 712, projections disc portion 220, fan-shaped disc portion 714 and projections disc portion 224 are placed in the passage of rising air discharged from the air outlet 230.

Contrary to fan-shaped disc portions 206, 210, 214, 218 and 222 of bubble generator 134 as discussed above with reference to FIG. 2, in accordance with aspects of the present invention, fan-shaped disc portions 706, 708, 710, 712 and 714 are rotatable. This will be described in greater detail with reference to FIGS. 8-10.

FIG. 8 is an oblique view of fan-shaped disc portion 708 of FIG. 7, in accordance with aspects of the present invention.

As shown in FIG. 8, fan-shaped disc portion 708 includes a cylindrical main body 802 and a plurality of projections, a sample projection indicated as item 804. Each of the plurality of projections extends from cylindrical main body 802 to a tip, a sample time indicated as item 806. Each of the plurality of projections have a length such that the tips are separated to form a hole 808 at the center of cylindrical main body 802.

Each of the plurality of projections of fan-shaped disc portion 708 is angled similar to a fan blade. Accordingly, as air bubbles pass through fan-shaped disc portion 708, the plurality of projections force the air bubbles toward the plurality of tips. A majority of the air bubbles are funneled toward hole 808.

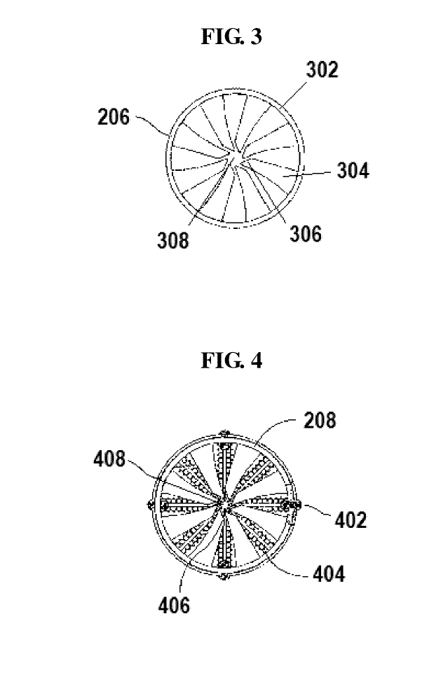

In contrast with fan-shaped disc portion 206 discussed above with reference to FIGS. 2-3, fan-shaped disc portion 708 in accordance with the present invention is rotatable. Depending on the angle of the plurality of projections, fan-shaped disc portion 708 may rotate in one of two directions. In this example embodiment, the plurality of projections are shaped such that when the bubbles bass through, a force is exerted on the plurality of projections, which forces rotation of fan-shaped disc portion 708 to rotate about a rotational axis. In this example, fan-shaped disc portion 708 is able to rotate in a counter-clockwise direction indicated by arrow 810. The rotation of fan-shaped disc portion 708 creates additional turbulence within the water, which in turn creates additional bubbles.

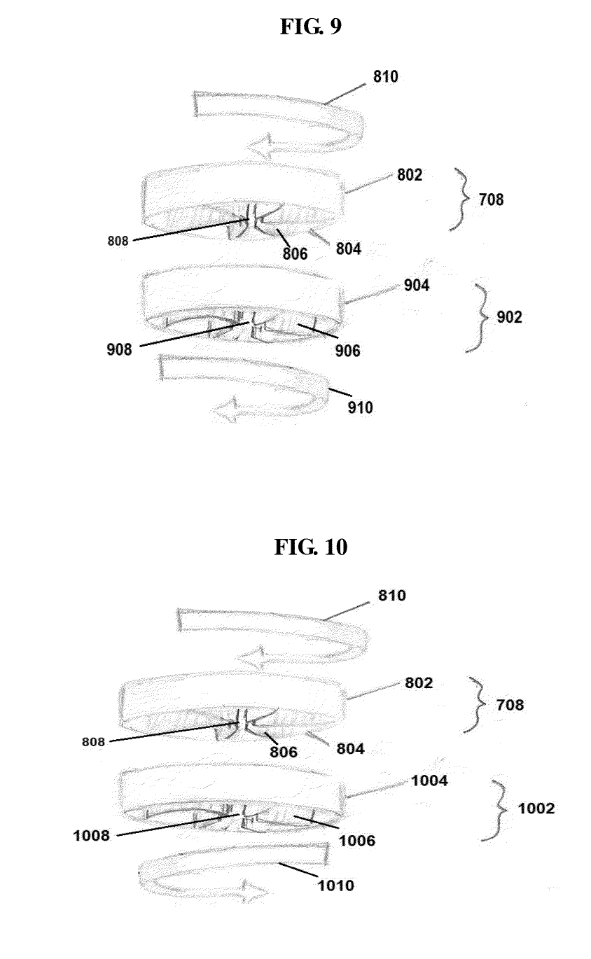

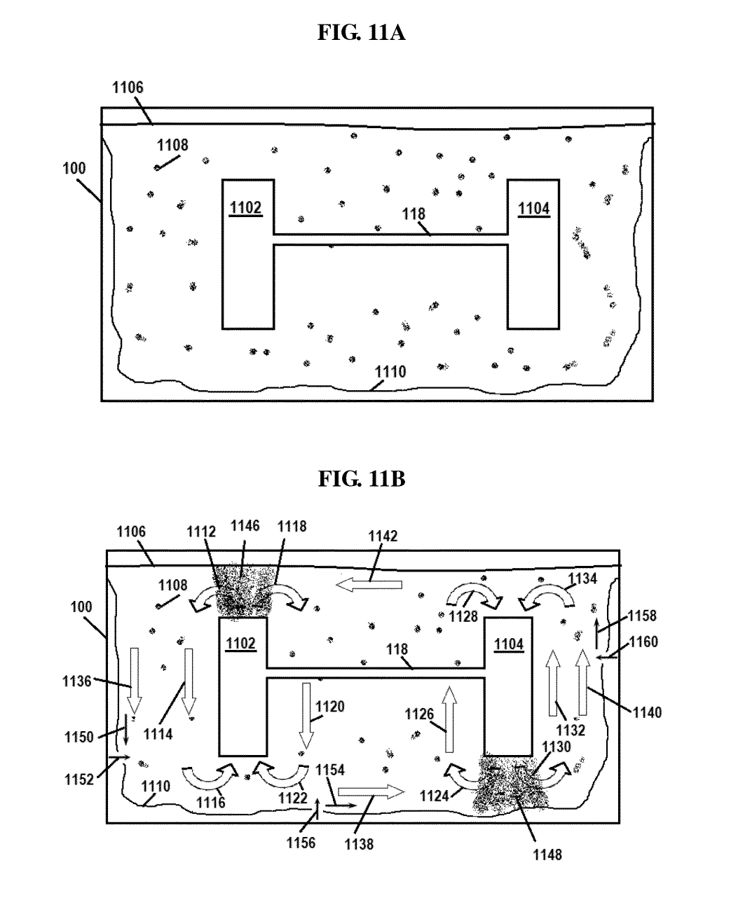

Returning to FIG. 7, bubble generator 702 includes a plurality of fan-shaped disc portions. Each may be arranges so as to rotate in a predetermined direction. This will be described in greater detail with reference to FIGS. 9-10.

FIG. 9 is an oblique view of fan-shaped disc portion 708 stacked on top of a fan-shaped disc portion 902, in accordance with aspects of the present invention.

As shown in FIG. 9, fan-shaped disc portion 902 includes a cylindrical main body 904 and a plurality of projections, a sample projection indicated as item 906. Each of the plurality of projections extends from cylindrical main body 904 to a tip. Each of the plurality of projections have a length such that the tips are separated to form a hole 908 at the center of cylindrical main body 904.

Similar to fan-shaped disc portion 708 discussed above with reference to FIG. 8, fan-shaped disc portion 902 in accordance with the present invention is rotatable. Depending on the angle of the plurality of projections, fan-shaped disc portion 902 may rotate in one of two directions. In this example embodiment, the plurality of projections are shaped such that when the bubbles bass through, a force is exerted on the plurality of projections, which forces rotation of fan-shaped disc portion 902 about a rotational axis. In this example embodiment, fan-shaped disc portion 902 is able to rotate in a counter-clockwise direction indicated by arrow 910. The rotation of fan-shaped disc portion 910 creates additional turbulence within the water, which in turn creates additional bubbles. In other words, in this example embodiment, fans-shaped disc portion 902 is operable to rotate about the same rotational axis, and in the same direction as fan-shaped disc portion 708.

The counter-clockwise directional rotation of fan-shaped disc portion 910 creates a general spiraling of the water in a counter-clockwise direction. This general spiraling of the water in a counter-clockwise direction is continued with the counter-clockwise rotation of fan-shaped disc portion 708.

It should be noted that a spacer, such as for example spacer 216, a projections disc portion, such as for example projections disc portion 220, or any combination or number thereof, may separate fan-shaped disc portion 708 from fan-shaped disc portion 902. This figure merely illustrates an arrangement of fan-shaped disc portions to rotate in a similar direction.

In another embodiment, the fan-shaped disc portions may be arranged to rotate in opposite directions. This will be described with reference to FIG. 10.

FIG. 10 is an oblique view of fan-shaped disc portion 708 stacked on top of a fan-shaped disc portion 1002, in accordance with aspects of the present invention.

As shown in FIG. 10, fan-shaped disc portion 1002 includes a cylindrical main body 1004 and a plurality of projections, a sample projection indicated as item 1006. Each of the plurality of projections extends from cylindrical main body 1004 to a tip. Each of the plurality of projections have a length such that the tips are separated to form a hole 1008 at the center of cylindrical main body 1006.

Similar to fan-shaped disc portion 708 discussed above with reference to FIG. 8, fan-shaped disc portion 1002 in accordance with the present invention is rotatable. Depending on the angle of the plurality of projections, fan-shaped disc portion 902 may rotate in one of two directions. In this example embodiment, the plurality of projections are shaped such that when the bubbles bass through, a force is exerted on the plurality of projections, which forces rotation of fan-shaped disc portion 1002 about a rotational axis. In this example embodiment, fan-shaped disc portion 1002 is able to rotate in a clockwise direction indicated by arrow 1010. The rotation of fan-shaped disc portion 1002 creates additional turbulence within the water, which in turn creates additional bubbles. In other words, in this example embodiment, fans-shaped disc portion 1002 is operable to rotate about the same rotational axis, but in a different direction as fan-shaped disc portion 708.

The clockwise directional rotation of fan-shaped disc portion 1002 creates a general spiraling of the water in a clockwise direction. This general spiraling of the water in a clockwise direction is disrupted by the counter-clockwise rotation of fan-shaped disc portion 708. The disruption creates additional turbulence, not encountered when two stacked fan-shaped disc portions rotate in a similar manner. This additional turbulence creates additional bubbles.

It should be noted that a spacer, such as for example spacer 216, a projections disc portion, such as for example projections disc portion 220, or any combination or number thereof, may separate fan-shaped disc portion 708 from fan-shaped disc portion 1002. This figure merely illustrates an arrangement of fan-shaped disc portions to rotate in an opposite direction.

With the rotating fan-shaped disc portion aspect discussed above with reference to FIGS. 7-10, additional bubbles and or water turbulence is created. The additional bubbles provide an increased chance to oxygenate the biological material and therefore increase its ability to break down grease. The additional turbulence promotes movement of the grease and the biological material within the water and therefore increase a likelihood of contact between the two. Accordingly, the rotating fan-shaped disc portion aspect discussed above with reference to FIGS. 7-10 provides an increased rate of grease breakdown over that of the conventional systems discussed above with reference to FIGS. 1-4.

With the rotating fan-shaped disc portion aspect discussed above with reference to FIGS. 7-10, additional bubbles and or water turbulence is created. The additional bubbles provide an increased chance to oxygenate the biological material and therefore increase its ability to break down grease. The additional turbulence promotes movement of the grease and the biological material within the water and therefore increase a likelihood of contact between the two. Accordingly, the rotating fan-shaped disc portion aspect discussed above with reference to FIGS. 7-10 provides an increased rate of grease breakdown over that of the conventional systems discussed above with reference to FIGS. 1-4.

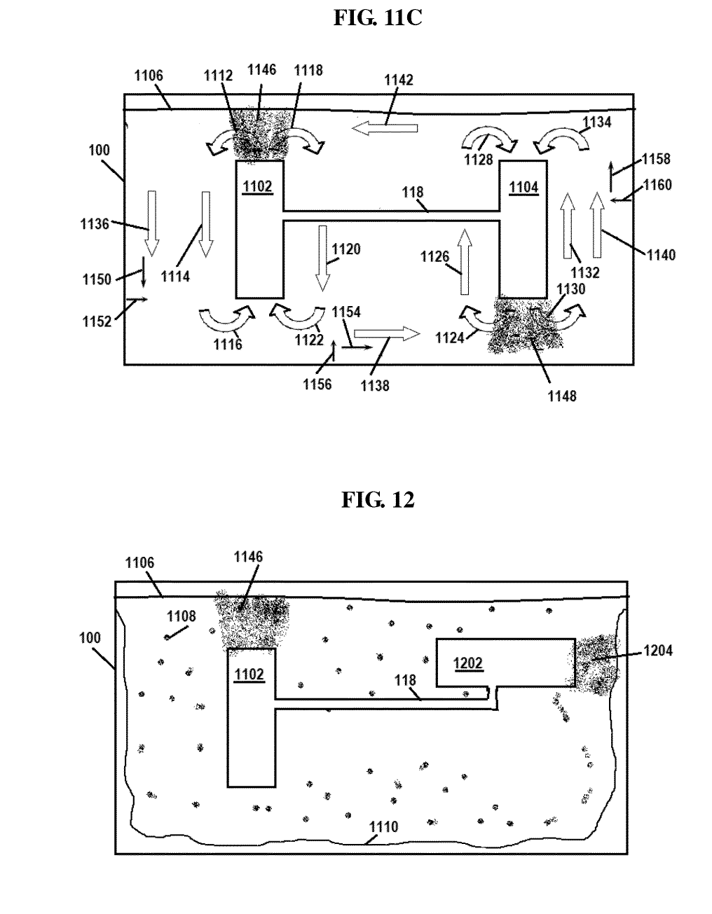

Another aspect in accordance with the present invention provides an increased rate of grease removal from the walls of the greasetrap over that of the conventional systems discussed above with reference to FIGS. 1-6. This aspect will now be described with reference to FIGS. 11A-12.

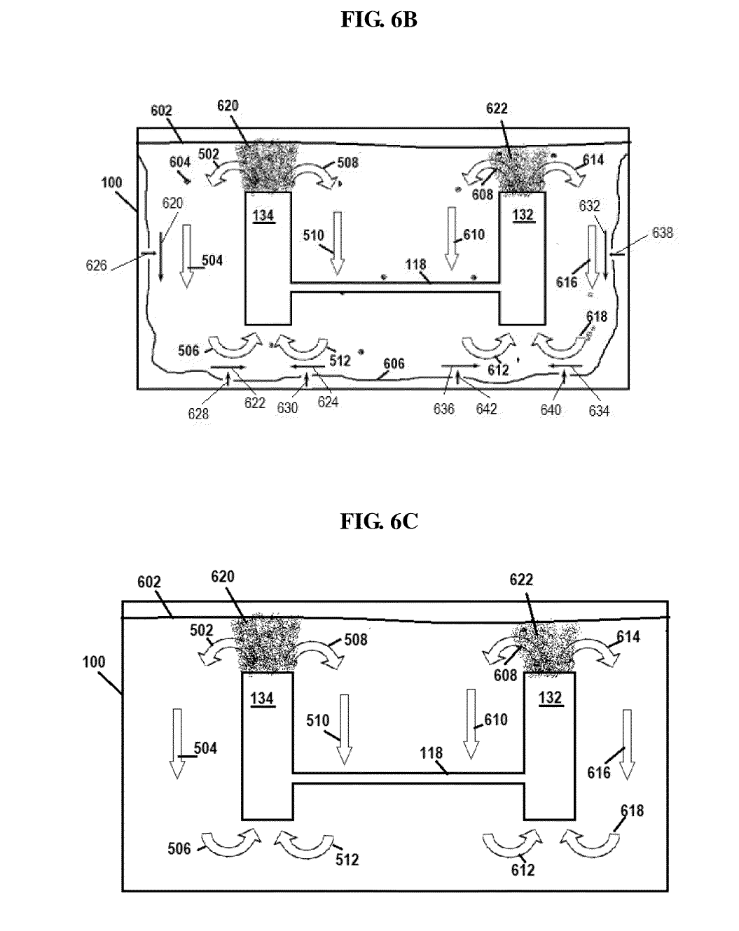

FIG. 11A is a cross-sectional view of grease trap 1100 and a grease trap cleaning system in accordance with aspects of the present invention along t-line 118 at a time t₀. In contrast with the conventional system discussed above with reference to FIG. 6A, in accordance with the present invention, each bubble generator is arranged to expel the bubbles in different directions.

As shown in the figure, grease trap 1100 is filled with water 1106, which includes grease particles 1108. Further, a layer of grease 1110 has formed along the walls and bottom of grease trap 100.

At some point, known biological microbes may be added to water 1106 to break down grease particles 1108. The biological microbes required oxygen to breakdown grease particles 1108.

FIG. 11B is a cross-sectional view of grease trap 100 and a grease trap cleaning system in accordance with the present invention along t-line 118 at a time t₁, wherein t-line 118 has been providing air to bubble generators 1102 and 1104 for a period of time. Of course a t-line is shown here for purposes of discussion. Any type of air provider may be used, wherein the air provider is operable to provide a flow of air to a first inlet of bubble generator 1102 and a second inlet of bubble generator 1104.

As shown in the figure, bubble generator 1102 generates a stream of very small bubbles 1146 in a first direction toward the top of grease trap 100. On the other hand, bubble generator 1104 generates a stream of very small bubbles 1148 in a second direction toward the bottom of grease trap 100. Stream of very small bubbles 1146 and stream of very small bubbles 1148 greatly oxygenate water 1106. The oxygenation enables breakdown of grease particles 1108 by the known biological microbes. By comparing FIG. 11A with FIG. 11B, the number of grease particles 1108 are greatly reduced.

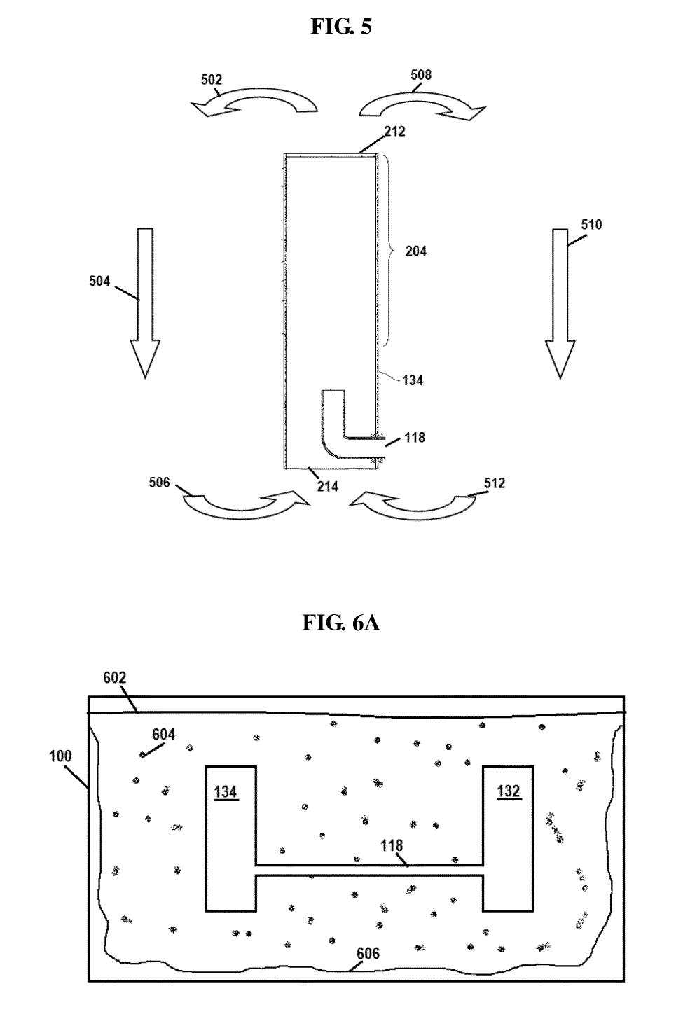

Similar to the manner discussed above with reference to FIG. 5, bubble generator 1102 creates fluid flow in the directions indicated by arrows 1112, 1114, 1116, 1118, 1120 and 1122. Bubble generator 1104 creates fluid flow in the directions indicated by arrows 1124, 1126, 1128, 1130, 1132 and 1134.

In accordance with an aspect of the present invention, bubble generators may be positioned such that the fluid flows created by one bubble generator constructively interferes with the fluid flows created by another bubble generator to create on overall increased fluid flow near the surface of the grease trap. For example, as shown in FIG. 11B, because bubble generator 1102 is arranged to create a flow in a direction indicated by arrow 1114 and because bubble generator 1104 is arranged to create a flow in a direction indicated by arrow 1132, an overall larger total flow is created in a direction indicated by arrows 1136, 1138, 1440, and 1142.

The fluid flowing as indicated by arrow 1136 has a velocity in the direction indicated by arrow 1150. As a result of the Bernoulli principle, the fluid flow in the direction indicated by arrow 1150 creates a decreased pressure in a direction normal to arrow 1150, indicated by arrow 1152. The decrease in pressure provides a pulling force from the wall of grease trap 100 in the direction of arrow 1152.

The fluid flowing as indicated by arrow 1138 has a velocity in the direction indicated by arrow 1154. As a result of the Bernoulli principle, the fluid flow in the direction indicated by arrow 1154 creates a decreased pressure in a direction normal to arrow 1154, indicated by arrow 1156. The decrease in pressure provides a pulling force from the wall of grease trap 100 in the direction of arrow 1156.

The fluid flowing as indicated by arrow 1140 has a velocity in the direction indicated by arrow 1158. As a result of the Bernoulli principle, the fluid flow in the direction indicated by arrow 1158 creates a decreased pressure in a direction normal to arrow 1158, indicated by arrow 1160. The decrease in pressure provides a pulling force from the wall of grease trap 100 in the direction of arrow 1160.

The pulling force from the wall of grease trap 100 in the direction of arrows 1152, 1156 and 1160 pulls grease from the wall of grease trap 100. Once freed from the wall, the grease may be more easily broken down by the microbes in the oxygenated water.

It should be noted that fluid flowing from bubble generator 1102 as indicated by arrow 1120 is opposite to fluid flowing from bubble generator 1104 as indicated by arrow 1126. While these fluid flows are opposite, they do not destructively interfere so as to “cancel” the fluid flow. The destructive interference creates additional turbulence between bubble generator 1102 and bubble generator 1104. The additional turbulence promotes movement of the grease and the biological material within the water and therefore increases a likelihood of contact between the two, which increases the rate of grease breakdown.

As a result of the pulling forces from the wall of grease trap 100 grease is pulled from the entire wall, as shown in FIG. 11C.

FIG. 11C is a cross-sectional view of grease trap 1100 and a grease trap cleaning system in accordance with aspects of the present invention along t-line 118 at a time t₂, wherein t-line 118 has been providing air to bubble generators 1102 and 1104 for an extended period of time.

As shown in the figure, no more grease particles are present in water 1106. Further, layer of grease 1110 is no longer present on the walls of grease trap 1100.

In the example embodiment discussed above with reference to FIGS. 11A-11C, the bubble generators are arranged to output flows of air in opposite directions. However, in other embodiments, bubble generators are arranged to output flows of air, not in opposite directions, but in different directions. This will be described in greater detail with reference to FIG. 12.

FIG. 12 is a cross-sectional view of grease trap 1100 and a grease trap cleaning system in accordance with aspects of the present invention along t-line 118 at a time t₀. In contrast with the system discussed above with reference to FIG. 11A, in accordance with the present invention, each bubble generator is arranged to expel the bubbles in different directions, yet not opposing directions.

FIG. 11B is a cross-sectional view of grease trap 100 and a grease trap cleaning system in accordance with the present invention along t-line 118 at a time t₁, wherein t-line 118 has been providing air to bubble generators 1102 and 1202 for a period of time.

As shown in the figure, bubble generator 1102 generates a stream of very small bubbles 1146 in a first direction toward the top of grease trap 100. On the other hand, bubble generator 1202 generates a stream of very small bubbles 1204 in a second direction toward the side of grease trap 100. Stream of very small bubbles 1146 and stream of very small bubbles 1204 greatly oxygenate water 1106. The oxygenation enables breakdown of grease particles 1108 by the known biological microbes.

In this example embodiment, fluid flows created by one bubble generator does not constructively interfere with the fluid flows created by another bubble generator to create on overall increased fluid flow near the surface of the grease trap, as in the embodiment discussed above with reference to FIG. 11. However, in this embodiment, the different directions of fluid flows create different types of turbulence to promote movement of the grease and the biological material within the water and therefore increase a likelihood of contact between the two, which increases the rate of grease breakdown.

In accordance with another aspect of the present invention, rotating fan-shaped disc portions discussed above with reference to FIGS. 7-10, may be used in bubble generators that are arranged to output a flow of air in different directions as discussed above with reference to FIGS. 11A-12.

In the example embodiments discussed above, a biological material is used to breakdown grease in a grease trap. However, this is a non-limiting example use of aspects of the present invention. Any type of material may be used to breakdown grease. Aspects of the present merely provide a manner of generating additional bubbles and increasing fluid flow within the grease trap.

In the example embodiments discussed above, a system and method is disclosed for breaking down grease in a grease trap. However, this is a non-limiting example use of aspects of the present invention. Any type of solute within a solution, wherein the solute precipitates in a trap may be used. Aspects of the present merely provide a manner of generating additional bubbles and increasing fluid flow within the solute trap.

In the example embodiments discussed above, the bubbles are generated with a supply of air. However, this is a non-limiting example use of aspects of the present invention. Any type of gas may be used that includes oxygen. If anaerobic microbes or a composition are used to break down a solute within the water, than any known gas may be used to facilitate the solute breakdown.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A wastewater treatment system for removing contaminants from a waste liquid by expelling bubbles into the liquid comprising:
a container to hold the liquid therein,
a gas provider having an input port, said input port being operable to connect to a gas supply to supply a flow of gas to be used for generating bubbles in the container;
a first bubble generator placed in the container, configured to draw in the gas supplied from the input port of the gas provider and the liquid in the container from a lower section, generate bubbles therein, and expel the generated bubbles upward together with the liquid drawn from the lower section; and
a second bubble generator placed in the container, configured to draw in the gas supplied from the input port of the gas provider and the liquid in the container from an upper section, generate bubbles therein, and expel the generated bubbles downward together with the liquid drawn from the upper section,
wherein each of the first and second bubble generators has a plurality of projections, with which the gas supplied from the gas provider is forced to collide, thereby inducing cavitation, and the induced cavitation in turn accelerates a velocity of the liquid and the bubbles passing through the respective bubble generator so that the liquid and bubbles are forced to expel upward from the first bubble generator and downward from the second bubble generator, thereby promoting to create a convection flow of bubbles within the container.

2. (canceled)

3. The wastewater treatment system of claim 1,
wherein the first bubble generator comprises
a inlet operable to connect to the gas provider to receive a portion of the flow of gas, and
a first cylindrical main body having a center, said first cylindrical main body being operable to rotate about a rotational axis and being arranged to receive the first portion of the flow of gas from said inlet in a direction along the rotational axis; and
wherein the plurality of projections are connected to said first cylindrical main body, each of said plurality of projections extending from said first cylindrical main body toward the center, each of said plurality of projections having a respective tip,
wherein said plurality of tips of said plurality of projections are arranged around an area of the center of said first cylindrical main body,
wherein the area has a size to induce cavitation in the first portion of the flow of gas at the area, and
wherein said plurality of projections are disposed to engage the first portion of the flow of gas to induce a rotation in a first direction about the rotational axis; and
wherein the second bubble generator comprises:
a inlet operable to connect to the as provider to receive a portion of the flow of gas, and
a second cylindrical main body having a second center, said second cylindrical main body being operable to rotate about the rotational axis and being arranged to receive the first portion of the flow of gas from said cylindrical main body a direction along the rotational axis; and
wherein the second plurality of projections connected to said second cylindrical main body, each of said second plurality of projections extending from said second cylindrical main body toward the second center, each of said second plurality of projections having a respective second tip,
wherein said second plurality of tips of said second plurality of projections are arranged around a second area of the second center of said second cylindrical main body,
wherein the second area has a size to induce cavitation in the first portion of the flow of gas at the second area, and
wherein said plurality of projections are disposed to engage the first portion of the flow of gas to induce a rotation in a second direction about the rotational axis.

4. (canceled)

5. The wastewater treatment system of claim 3, wherein the first direction about the rotational axis is the same as the second direction about the rotational axis.

6. The wastewater treatment system of claim 5, further comprising a spacer disposed between said first cylindrical main body and said second cylindrical main body.

7. The wastewater treatment system of claim 3, wherein the first direction about the rotational axis is different from the second direction about the rotational axis.

8. The wastewater treatment system of claim 7, further comprising a spacer disposed between said first cylindrical main body and said second cylindrical main body.

9. The wastewater treatment system of claim 3, further comprising:
a second inlet operable to connect to the gas supply to receive a second portion of the flow of gas;
a third cylindrical main body having a third center, said third cylindrical main body being operable to rotate about a second rotational axis and being arranged to receive the second portion of the flow of gas from said second inlet in a direction along the second rotational axis; and
a third plurality of projections connected to said third cylindrical main body, each of said third plurality of projections extending from said third cylindrical main body toward the third center, each of said third plurality of projections having a respective third tip,
wherein said third plurality of tips of said third plurality of projections are arranged around a third area of the third center of said third cylindrical main body,
wherein the third area has a size to induce cavitation in the second portion of the flow of gas at the third area, and
wherein said third plurality of projections are disposed to engage the second portion of the flow of gas to induce a rotation in a third direction about the second rotational axis.

10. The wastewater treatment system of claim 9, further comprising:
a fourth cylindrical main body having a fourth center, said fourth cylindrical main body being operable to rotate about the second rotational axis and being arranged to receive the second portion of the flow of gas from said third cylindrical main body a direction along the second rotational axis; and
a fourth plurality of projections connected to said fourth cylindrical main body, each of said fourth plurality of projections extending from said fourth cylindrical main body toward the fourth center, each of said fourth plurality of projections having a respective fourth tip,
wherein said fourth plurality of tips of said fourth plurality of projections are arranged around a fourth area of the fourth center of said fourth cylindrical main body,
wherein the fourth area has a size to induce cavitation in the second portion of the flow of gas at the fourth area, and
wherein said fourth plurality of projections are disposed to engage the second portion of the flow of gas to induce a rotation in a fourth direction about the second rotational axis.

11. The wastewater treatment system of claim 10, wherein the third direction about the second rotational axis is the same as the fourth direction about the second rotational axis.

12. The wastewater treatment system of claim 11, further comprising a spacer disposed between said third cylindrical main body and said fourth cylindrical main body.

13. The wastewater treatment system of claim 10, wherein the third direction about the second rotational axis is different from the fourth direction about the second rotational axis.

14. The wastewater treatment system of claim 13, further comprising a spacer disposed between said third cylindrical main body and said fourth cylindrical main body.

15. A method of treating wastewater using a wastewater treatment system with a gas supply and a container having liquid therein, the gas supply being operable to supply a flow of gas, the wastewater treatment system including a gas provider, a first bubble generator and a second bubble generator, the gas provider having an input port, a first output port and a second output port, the input port being connect to the gas supply, the first bubble generator having a first inlet and a first outlet and being connected to the gas provider such that a first portion of the flow of gas is provided to the first inlet from the first output port, the second bubble generator having a second inlet and a second outlet and being connected to the gas provider such that a second portion of the flow of gas is provided to the second inlet from the second output port, the first and second bubble generators each having a plurality of projections;
said method comprising:
arranging the first bubble generator in the liquid to output the first portion of the flow of gas from the first outlet into the liquid in a upward direction together with a portion of the liquid;
arranging the second bubble generator in the liquid to output the second portion of the flow of gas from the second outlet into the liquid in a downward direction together with a portion of the liquid;
providing the flow of gas to the input port; and
arranging the plurality of projections to collide with the flow of gas, thereby inducing cavitation, the induced cavitation in turn accelerating a velocity of the liquid and the bubbles passing through the respective bubble generator so that the liquid and bubbles are forced to expel upward from the first bubble generator and downward from the second bubble generator, thereby promoting to create a convection flow of bubbles within the container.
